(19) United States
(12) Patent Application Publication
(10) Pub. No.: US 2026/0361203 A1
(43) Pub. Date: Nov. 12, 2026

(54) Electronic Device with Frequency Dithering and Amplitude Modulation Compensation

(71) Applicant: Apple Inc., Cupertino, CA (US)

(72) Inventors: Girish V Varatkar, Sammamish, WA (US); Sriram Narayanan, Los Gatos, CA (US); Adam L Schwartz, Redwood City, CA (US); Stephen C Terry, San Jose, CA (US)

(21) Appl. No.: 19/554,884

(22) Filed: Mar. 3, 2026

Related U.S. Application Data
(60) Provisional application No. 63/804,310, filed on May 12, 2025.

(51) Int. Cl. H02M 1/00; H02J 50/10; H02J 50/80; H02M 7/5387

(52) U.S. Cl. CPC H02M 1/0038; H02J 50/10; H02J 50/80; H02M 7/53873

(57) ABSTRACT

An electronic device may include an inverter. The inverter may receive switching signals based on a dithered clock signal and output corresponding alternating current signals to a wireless power transfer coil. The electronic device may include amplitude-shift keying communication receiving circuitry that compensates for amplitude modulation caused by the dithering of the clock signal.

### CROSS REFERENCE TO RELATED APPLICATIONS

This application claims the benefit of U.S. provisional patent application No. 63/804,310, filed May 12, 2025, which is hereby incorporated by reference herein in its entirety.

### FIELD

This relates generally to wireless power transfer, and, more particularly, to improvements for robust data communications during wireless power transfer.

### BACKGROUND

Electronic devices sometimes include inverters that convert direct current (DC) power to alternating current (AC) power. The inverter may use a clock signal at a given frequency to output corresponding alternating current signals. The clock signal that is used to control the inverter may be dithered by the electronic device, effectively dithering the frequency of the alternating current signals output by the inverter. Dithering the frequency of the alternating current signals may cause periodic amplitude modulations in the alternating current signals output by the inverter. It is desirable to compensate the alternating current signals output by the inverter for the periodic amplitude modulations caused by frequency dithering.

### SUMMARY

A power transmitting device may include a wireless power transfer coil configured to transmit wireless power to an additional wireless power transfer coil of a power receiving device, an inverter configured to receive switching signals based on a dithered clock signal and output a wireless power transfer signal to the wireless power transfer coil, and a data communications receiver coupled to the wireless power transfer coil and configured to receive data communications from the power receiving device. The wireless power transfer coil and the additional wireless power transfer coil may establish an inductive communication channel that experiences variable gain sensitive to signal frequency. The wireless power transfer signal may be dithered, using the dithered clock signal, about a nominal wireless power transmission frequency. The data communications receiver may be further configured to normalize the wireless power transfer signal by compensating for amplitude modulations related to the variable gain of the inductive communication channel and decode, using the normalized wireless power transfer signal, amplitude modulations related to amplitude-shift-keying communications to obtain the data communications from the power receiving device. The data communications from the power receiving device may be used to negotiate and control power transfer between the power transmitting device and the power receiving device.

### BRIEF DESCRIPTION OF THE DRAWINGS

FIG. 1 is a schematic diagram of an illustrative wireless power system in accordance with some embodiments.

FIG. 2 is a schematic diagram of illustrative wireless power transmitting circuitry and wireless power receiving circuitry in a wireless power system in accordance with some embodiments.

FIG. 3 is a schematic diagram of an illustrative inverter in accordance with some embodiments.

FIG. 4 is a schematic diagram of an illustrative electronic device that includes dithering circuitry in accordance with some embodiments.

FIG. 5 is a graph of an illustrative dithered clock signal with a triangular shape in accordance with some embodiments.

FIG. 6 is a graph of an illustrative dithered clock signal with a sawtooth shape in accordance with some embodiments.

FIG. 7 is a graph of an illustrative dithered clock signal with a sinusoidal shape in accordance with some embodiments.

FIG. 8 is a graph of illustrative signal envelopes for wireless power transfer signals with and without frequency dithering in accordance with some embodiments.

FIG. 9 is a schematic diagram of illustrative amplitude-shift keying (ASK) communication receiving circuitry that includes amplitude modulation compensation circuitry in accordance with some embodiments.

FIG. 10 is a graph of an illustrative signal envelope for a wireless power transfer signal that undergoes amplitude modulation compensation in accordance with some embodiments.

FIG. 11 is a flowchart showing an illustrative method of operating a power transmitting device with ASK communication receiving circuitry that includes amplitude modulation compensation circuitry in accordance with some embodiments.

### DETAILED DESCRIPTION

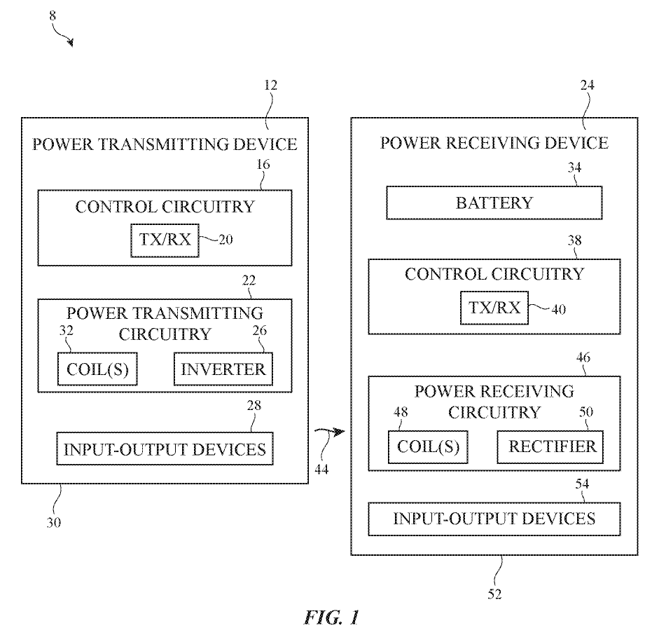

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be called software, data, program instructions, instructions, or code. The non-transitory computer readable storage media may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user’s head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user’s head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power transfer signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400kHz, 1-100MHz, between 1.7MHz and 1.8MHz, less than 2 MHz, between 100kHz and 2MHz, 128kHz, 326 kHz, 360 kHz, 6.78MHz, 13.56MHz, etc.). Rectifier circuitry such as rectifier circuitry 50, which contains rectifying components such as synchronous rectification transistors arranged in a bridge network, converts received AC signals (received alternating-current signals associated with wireless power transfer signals 44) from one or more coils 48 into DC voltage signals for powering PRX device 24. Wireless power transfer signals 44 are sometimes called wireless power 44, wireless charging signals 44, wireless power signals 44, etc. Coils 32 are sometimes called wireless power transfer coils 32, wireless charging coils 32, or wireless power transmitting coils 32. Coils 48 are sometimes called wireless power transfer coils 48, wireless charging coils 48, or wireless power receiving coils 48.

The DC voltage produced by rectifier circuitry 50 (sometime called rectifier output voltage Vrect) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

The example in FIG. 1 of PRX device 24 including battery 34 is illustrative. More generally, an electronic device may include a power storage device 34. Power storage device 34 may be a battery, or may be, for example, a supercapacitor that stores charge.

PTX device 12 and PRX device 24 may communicate wirelessly using in-band or out-of-band-communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications and wireless transceiver circuitry 20 may demodulate the wireless charging signal 44 to obtain the data that is being communicated.

Implementations using out-of-band-communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions. Antennas used for out-of-band communications may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power transfer signals using coil(s) 32 and PRX 24 may optionally be capable of transmitting wireless power transfer signals using coil(s) 48. When a device is capable of both transmitting and receiving wireless power transfer signals, the device may include both an inverter and a rectifier.

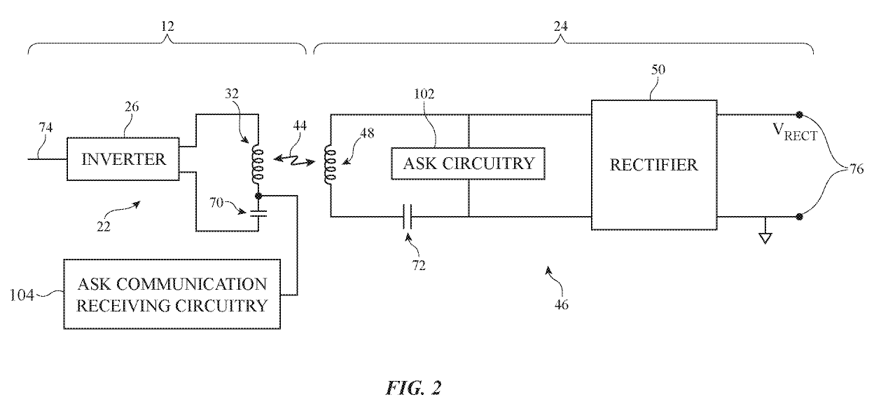

FIG. 2 is a circuit diagram of illustrative wireless charging circuitry for system 8. As shown in FIG. 2, circuitry 22 may include inverter circuitry such as one or more inverters 26 or other drive circuitry that produces wireless power transfer signals that are transmitted through an output circuit that includes one or more coils 32 and capacitors such as capacitor 70. In some embodiments, device 12 may include multiple individually controlled inverters 26, each of which supplies drive signals to a respective coil 32. In other embodiments, an inverter 26 is shared between multiple coils 32 using switching circuitry.

During operation, control signals for inverter(s) 26 are provided by control circuitry 16 at control input(s) 74. A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26. During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24.

Rectifier circuitry 50 is coupled to one or more coils 48 and converts received power from AC to DC and supplies a corresponding direct current output voltage Vrect across rectifier output terminals 76 for powering load circuitry in device 24 (e.g., for charging battery 34, for powering a display and/or other input-output devices 54, and/or for powering other components).

As shown in FIG. 2, wireless power receiving circuitry 46 includes amplitude-shift-keying (ASK) circuitry 102 (which may be considered part of wireless transceiver circuitry 40). The ASK circuitry may include, as one example, a series connected capacitor and a switch that are parallel to the coil 48. Closing and opening the switch changes the impedance of wireless power receiving circuitry 46, which induces a corresponding perturbation in amplitude at the signal through coil 32 in power transmitting circuitry 22. Modulating the state of the switch in ASK circuitry 102 may therefore be used to transmit ASK modulation states from power receiving device 24 to power transmitting device 12. This example is merely illustrative and there are other possible ways of achieving ASK modulation (e.g., varying the rectifier load). In general, any desired ASK modulation techniques may be used. Wireless power transmitting circuitry 22 may include ASK communication receiving circuitry 104 (which may be considered part of wireless transceiver circuitry 20) that is used to decode the ASK modulation states into corresponding bits. ASK communication receiving circuitry 104 (sometimes called data communications receiver 104, ASK receiver 104, etc.) monitors the amplitude and/or phase of the AC signal passing through coil(s) 32 and, using ASK demodulation, extracts the transmitted in-band data from these signals that were transmitted by ASK circuitry 102. The use of ASK communications allows data bits to be transmitted in-band from device 24 to device 12 with coils 48 and 32 while power is simultaneously being wirelessly conveyed from device 12 to device 24 using coils 32 and 48. Multiple data bits taken together can constitute data packets for communication between devices 12 and 24.

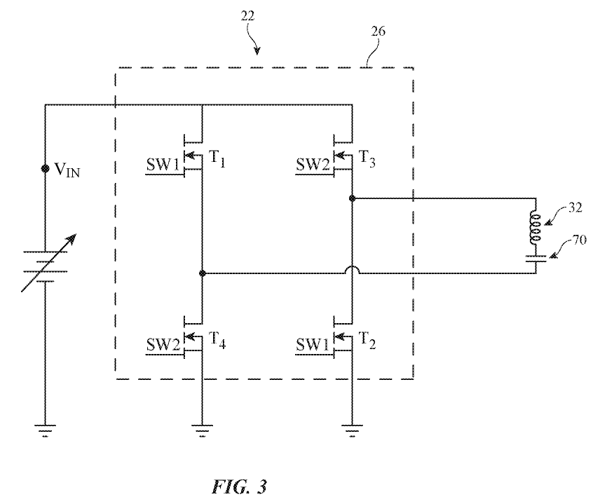

FIG. 3 is a circuit diagram showing an arrangement for inverter 26 in power transmitting circuitry 22. As shown in FIG. 3, inverter 26 may be a full-bridge inverter that includes four switches arranged in a bridge configuration. Switches T₁ and T₄ are connected in series between a control terminal that provides an adjustable voltage V_{IN} and ground. In parallel to switches T₁ and T₄, switches T₃ and T₂ are connected in series between the control terminal that provides adjustable voltage V_{IN} and ground. Coil 32 and capacitor 70 are connected between a first node between T₁ and T₄ and a second node between T₂ and T₃. The four switches (T₁, T₂, T₃, and T₄) may be power metal-oxide-semiconductor field-effect transistors (MOSFETs), insulated-gate bipolar transistors (IGBTs), or other desired switching components. FIG. 3 shows an example where switches T₁, T₂, T₃, and T₄ (sometimes called transistors T₁, T₂, T₃, and T₄) are power MOSFETs.

During operation of inverter 26, transistors T₁, T₂, T₃, and T₄ may be switched on and off in pairs. In an example where the duty cycle is equal to 50%, one pair of transistors (e.g., transistors T₁ and T₂) conducts (is turned on) during one half-cycle of the output waveform while the other pair is turned off. Then, during the next half-cycle, the conducting transistors (T₁ and T₂) are switched off, and the previously turned-off transistors (T₃ and T₄) are turned on. This process is repeated to generate the desired AC output waveform as input to wireless power transfer coil 32.

FIG. 3 shows an example where transistors T₁ and T₂ receive a common control signal SW1 and transistors T₃ and T₄ receive a common control signal SW2. Control signals SW1 and SW2 may be alternatively switched between first and second states (e.g., high and low states) to operate inverter 26.

The example in FIG. 3 of the inverter output being coupled to a wireless power transfer coil is merely illustrative. In general, an inverter output may be coupled to a wireless power transfer coil (as in FIGS. 2 and 3), a transformer coil, an antenna, or any other desired component.

Some electronic devices with inverters, such as PTX 12 discussed with reference to FIGS. 1-3, employ signal dithering to improve electromagnetic emission characteristics of the system (e.g., to reduce conducted emission and/or radiated emission). For example, PTX 12 may dither the clock signal that is used to control inverter 26. This effectively dithers the frequency of the alternating current signals output by inverter 26.

Herein, various signals (e.g., clock signals) may be referred to as having corresponding waveforms (e.g., the shape of the voltage of the signal over time). A given waveform may have a recurring shape that repeats at a given frequency (i.e., the given waveform may be periodic). The recurring shape need not necessarily be a regular shape (e.g., a sinusoid). Indeed, the recurring shape may deviate from a sinusoidal shape. However, this type of waveform may still have a frequency associated with the periodic repeating of the non-sinusoidal shape.

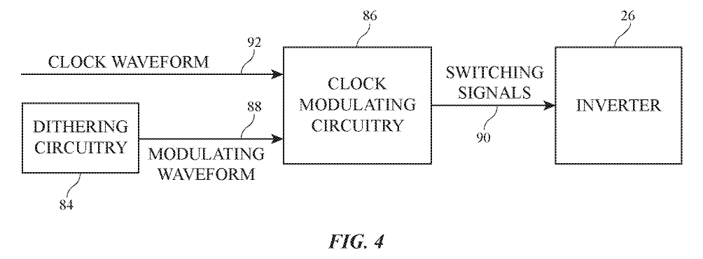

FIG. 4 is a diagram of an illustrative PTX 12 with dithering circuitry. In one possible arrangement, dithering circuitry 84 and clock modulating circuitry 86 may be used to implement a spread spectrum clocking technique, sometimes called clock dithering. Dithering circuitry 84 and clock modulating circuitry 86 may be considered part of control circuitry 16. Dithering circuitry 84 and clock modulating circuitry 86 may produce a clock waveform that is spread around the target frequency for the clock signal. This target frequency is sometimes called the fundamental frequency for the clock signal. This improves the electromagnetic compatibility (EMC) associated with the target frequency of the clock signal. Dithering circuitry 84 may determine a modulating waveform 88 that is used to modulate the clock waveform 92 (sometimes called native clock waveform 92, initial clock waveform 92, undithered clock waveform 92, system clock 92, etc.). To improve EMC, modulating waveform 88 is applied to clock waveform 92 by clock modulating circuitry 86. Clock modulating circuitry 86 may use modulating waveform 88 to frequency modulate clock waveform 92. The resulting switching signal 90 (sometimes called modified clock signal 90, dithered clock signal 90, dithered switching signal 90, etc.) are then provided to inverter 26 to create a frequency dithered AC signal for wireless power transfer to a power receiving device.

The modulating waveform 88 output by dithering circuitry 84 may be fixed or may be adjusted based on real time operating conditions of wireless power system 8. For example, dithering circuitry 84 may generate modulating waveform 88 based on operating characteristics of WPT system 8, a state of charge of battery 34 in PRX 24, an output voltage and/or current of rectifier 50, an output voltage and/or current of coil 48, a voltage and/or current of coil 32, an input voltage and/or current of inverter 26, etc.

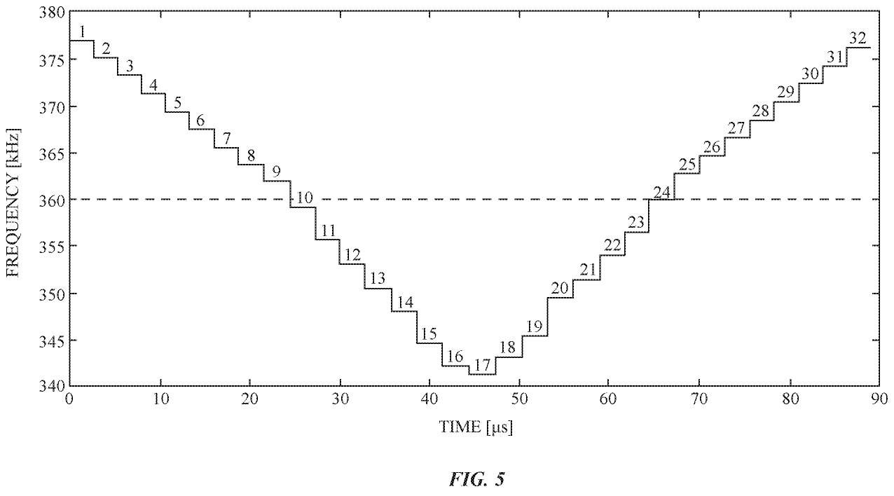

FIG. 5 is a graph of an example dithered clock signal that may be provided to inverter 26 in PTX 12. The example dithered clock signal of FIG. 5 may be used for a PTX with a designated wireless power transmission frequency (sometimes called the nominal wireless power transmission frequency or simply the wireless power transmission frequency) of 360 kHz. In the example of FIG. 5, the dithered clock signal is a stepwise function that approximates a triangular waveform. The dithered clock signal is thus referred to as having a triangular shape. The dithered clock signal of FIG. 5 may be repeated in a plurality of repeated cycles. Each repeated cycle may include one period of the waveform shown in FIG. 5.

In the illustrated example, there are 32 frequency steps in one repeated cycle of the dithered clock signal. The y-axis of FIG. 5 shows the instantaneous frequency of the clock signal over time. The duration of each frequency step is equal to 1/fₛ (where fₛ is the instantaneous frequency of the clock signal). In other words, the dithered clock signal remains at each frequency step for one period at the instantaneous frequency associated with that frequency step.

In the illustrated example, each one of the 32 frequency steps has a different frequency magnitude, relative to their neighboring steps, within the period of the dithered clock signal. In addition, each of the frequency steps is unique relative to all of the other frequency steps in the period. The 32 unique frequency steps have a first subset of falling steps (sometimes called decreasing steps) where the frequency magnitude decreases with each subsequent step of the waveform. The 32 unique frequency steps have a second subset of rising steps (sometimes called increasing steps) where the frequency magnitude increases with each subsequent step of the waveform.

In the example of FIG. 5, steps 1-17 are the falling steps of the waveform and steps 18-32 are the rising steps of the waveform. The middle step of the rising steps (i.e., step 24) is equal to the wireless power transmission frequency of 360kHz. The middle step of the falling steps (i.e., step 9) is close to the wireless power transmission frequency of 360kHz (though not exactly equal to 360kHz because step 24 is already equal to 360kHz and each frequency step has a unique frequency magnitude).

The frequency magnitudes of the frequency steps are equal to 376.96kHz, 375.00kHz, 373.06kHz, 371.13kHz, 369.23kHz, 367.35kHz, 365.48kHz, 363.64kHz, 361.81kHz, 359.10kHz, 355.56kHz, 352.94kHz, 350.36kHz, 347.83kHz, 344.50kHz, 342.04kHz, 341.23kHz, 342.86kHz, 345.32kHz, 349.51kHz, 351.22kHz, 353.81kHz, 356.44kHz, 360kHz, 362.72kHz, 364.56kHz, 366.41kHz, 368.29kHz, 370.18kHz, 372.09kHz, 374.03kHz, and 375.98kHz (in that order).

The modulation frequency (fₘ) of the dithered clock signal may be equal to the inverse of the period of the waveform of FIG. 5. Because each frequency step has a duration of one period at the instantaneous frequency at that frequency step and the dithered clock signal is centered around the designated wireless power transmission frequency, the modulation frequency of the dithered clock signal may also be equal to the wireless power transmission frequency divided by the number of steps in the frequency profile. The modulation frequency of the dithered clock signal of FIG. 5 is therefore 11.25kHz (e.g., 360kHz / 32 = 11.25kHz).

The dithered clock signal of FIG. 5 may also have a characteristic frequency deviation Δf. The magnitude of Δf may be equal to the maximum difference between a frequency magnitude of the dithered clocks signal and the wireless power transmission frequency. In the waveform of FIG. 5, frequency step 1 has the maximum frequency and frequency step 17 has the minimum frequency. Frequency step 17 may have the greatest deviation from the wireless power transmission frequency and therefore the magnitude of Δf is equal to 360kHz minus the frequency at step 17. Herein the frequency at step 17 may be equal to 341.23kHz and Δf therefore is equal to 18.77kHz.

The dithered clock signal of FIG. 5 has a characteristic modulation index (h) that is defined as Δf/fₘ. For the waveform of FIG. 5, the modulation index is equal to 1.67 (e.g., 18.77kHz / 11.25kHz = 1.67).

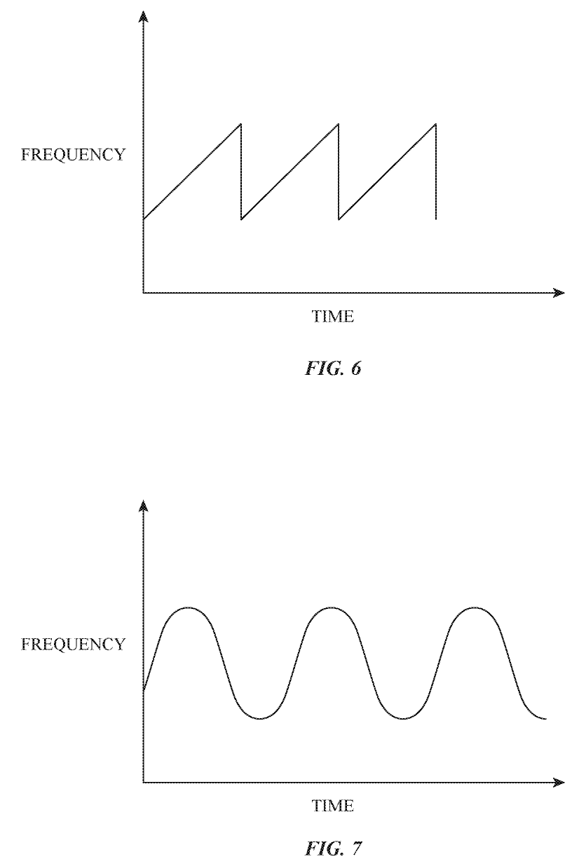

The triangular example of FIG. 5 is merely illustrative and other waveforms are possible. For example, the dithered clock signal may instead be a stepwise function that approximates a sawtooth waveform signal (as shown in the example of FIG. 6), a sinusoidal waveform signal (as shown in the example of FIG. 7), or a waveform of any other desired shape. The dithered clock signal may be non-monotonic (e.g., with multiple discrete increases and decreases in frequency across the repeated cycle of the dithered clock signal) if desired.

Other characteristics of a dithered clock signal, such as steps, modulation frequencies (fₘ), and/or frequency deviations (Δf) may also vary in different implementations, resulting in various modulation indices (h). For example, the modulating frequency fₘ of the dithered clocks signal may be greater than 9kHz, greater than 10kHz, greater than 11kHz, greater than 15kHz, less than 30kHz, less than 20kHz, etc. The number of frequency steps in the repeating waveform may be less than 40, less than 20, less than 10, greater than 6, greater than 15, greater than 30, etc. The magnitude of the modulation index (h) for the dithered clock signal may be less than 2.0, less than 1.9, less than 1.8, less than 1.7, less than 1.6, greater than 1.4, greater than 1.5, greater than 1.6, between 1.4 and 1.8, between 1.5 and 1.7, between 1.6 and 1.7, etc. The magnitude of the frequency deviation (Δf) for the dithered clock signal may be greater than 5kHz, greater than 10kHz, greater than 15kHz, greater than 20kHz, greater than 30kHz, less than 20kHz, less than 15kHz, between 10kHz and 30kHz, between 10kHz and 20kHz, etc. The magnitude of the frequency deviation (Δf) for the dithered clock signal may be less than 20% the wireless power transmission frequency, less than 10% the wireless power transmission frequency, less than 5% the wireless power transmission frequency, less than 3% the wireless power transmission frequency, greater than 1% the wireless power transmission frequency, greater than 2% the wireless power transmission frequency, greater than 5% the wireless power transmission frequency, greater than 10% the wireless power transmission frequency, between 1% and 10% of the wireless power transmission frequency, etc.

It is preferable that a dithered clock signal has a time-weighted average frequency that is adjacent the nominal wireless power transmission frequency. For example, a dithered clock signal may have a time-weighted average frequency within 1kHz of 360kHz (e.g., between 359kHz and 361kHz when the nominal wireless power transmission frequency is 360kHz). As another example, a dithered clock signal may have a time-weighted average frequency between 127kHz and 129kHz when the nominal wireless power transmission frequency is 128kHz.

During wireless power transmission, dithering the clock signal (e.g., using the pattern of one of FIGS. 5-7) may cause amplitude modulation in the wireless power transfer signal. Different frequencies for the wireless power transfer signal may have different associated gain magnitudes in the inductive link between PTX 12 and PRX 24. In the example of wireless power transfer system 8, operating frequency is inversely related to gain between PTX 12 and PRX 24. In particular, a higher frequency has a lower associated gain and output voltage (Vrect) whereas a lower frequency has a higher associated gain and output voltage. The different gain magnitudes at the different frequencies cause amplitude modulation in the wireless power transfer signal.

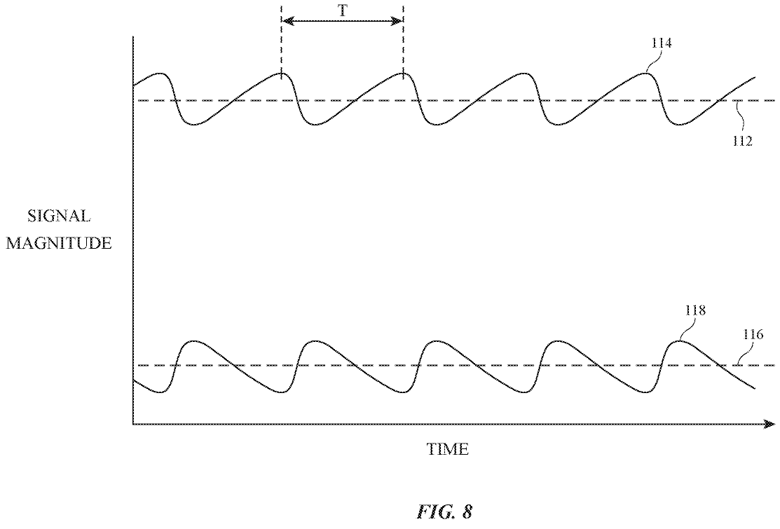

FIG. 8 illustrates this phenomenon. The amplitude modulation caused by the dithered clock signal may be reflected in modulation of the upper and lower envelopes of the wireless power transfer signal. Profile 112 shows the upper envelope for the wireless power transfer signal in a scenario where dithering is not being performed and ASK communications are not being received. In this scenario, the signal magnitude of the upper envelope (e.g., with units of Volts) is constant. Similarly, profile 116 shows the lower envelope for the wireless power transfer signal in a scenario where dithering is not being performed and ASK communications are not being received. In this scenario, the signal magnitude of the lower envelope is constant.

When the upper and lower envelopes are constant (as in profiles 112 and 116) in the absence of ASK communications, changes in amplitude of the wireless power transfer signal may be attributed to incoming ASK communications, thereby providing a more optimal operating condition in which ASK communications may be received at a high bit rate with little to no errors.

In contrast, frequency dithering the wireless power transfer signal may cause amplitude modulation in the wireless power transfer signal (e.g., modulation to the upper and lower envelopes of the wireless power transfer signal). Profile 114 shows the upper envelope for the wireless power transfer signal in a scenario where dithering is being performed (e.g., according to the pattern of FIG. 5) and ASK communications are not being transmitted. In this scenario, even though ASK communications are not being transmitted, the signal magnitude of the upper envelope varies periodically. Similarly, profile 118 shows the lower envelope for the wireless power transfer signal in a scenario where dithering is being performed (e.g., according to the pattern of FIG. 5) and ASK communications are not being transmitted. In this scenario, even though ASK communications are not being transmitted, the signal magnitude of the lower envelope varies periodically. These excess modulations decrease the signal-to-noise ratio of the ASK communication channel and reduce the performance of ASK communications between PRX 24 and PTX 12 (e.g., by causing bit errors in the ASK demodulation).

To increase the speed and accuracy of ASK communications from PRX 24 to PTX 12, PTX 12 may, in its decoding of inbound ASK communications, compensate for the amplitude modulation caused by its frequency dithering of the wireless power transfer signal. After the wireless power transfer signal is compensated for amplitude modulation caused by frequency dithering, the remaining amplitude modulation may be attributable to incoming ASK communications.

To compensate for the amplitude modulation caused by frequency dithering, compensation factors may be determined by ASK communication receiving circuitry 104 during a quiet period (sometimes called a quiet time, quiet duration, quiet interval, quiet phase, etc.) in which no ASK packets are expected and/or received from PRX 24. To determine compensation factors, PTX 12 may sample the wireless power transfer signal to determine a signal envelope, which includes varying amplitude modulations caused by frequency dithering. PTX 12 may also determine compensation factors that would offset the undesired signal modulations introduced by dithering. The compensation factors may normalize the signal amplitude to a constant (or near-constant) magnitude, corresponding to a non-dithered wireless power transfer signal. Notably, as PTX 12 is also generating the frequency-dithered wireless power transfer signal, PTX 12 may utilize its knowledge of the wireless power transfer signal (e.g., operating frequency) and dithering clock signal (e.g., steps and clock frequency adjustments), at a given moment, in order to determine signal compensation factors that would optimally normalize the wireless power transfer signal at that given moment in time.

After the compensation factors are determined, when PTX 12 receives ASK data communication packets from PRX 24, ASK communication receiving circuitry 104 may normalize the wireless power transfer signal, inclusive of the data communication modulations, using the compensation factors. The compensation factors would normalize, or effectively remove, amplitude modulations that are attributable to frequency dithering, leaving in place the amplitude modulations that are attributable to ASK data communications. ASK communication receiving circuitry 104 of PTX 12 may use the resulting wireless power transfer signal (i.e., the partially normalized signal) to decode ASK packets included in the wireless power transfer signal.

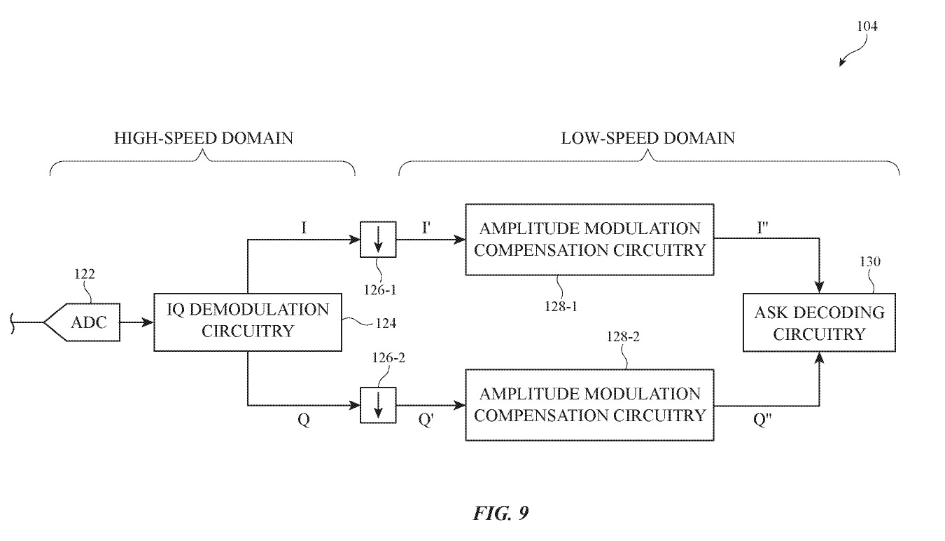

FIG. 9 is a schematic diagram of illustrative ASK communication receiving circuitry 104 (sometimes called a data communications receiver 104, ASK communication receiver 104, ASK decoder 104, etc.). As shown in FIG. 9, ASK communication receiving circuitry 104 includes an analog-to-digital converter (ADC) 122, IQ demodulation circuitry 124, down-converter circuitry 126-1 and 126-2, amplitude modulation compensation circuitry 128-1 and 128-2, and ASK decoding circuitry 130. ADC 122 may receive an analog signal (e.g., from coil 32) and convert the analog signal to a digital signal at a first sampling rate. The first sampling rate (sometimes called a high-speed sampling rate) may be in the order of mega-samples per second (MS/s), such as 8 MS/s. The digital samples from the ADC may then undergo IQ demodulation by IQ demodulation circuitry 124. IQ demodulation circuitry 124 (sometimes called IQ demodulator 124) may receive a digital signal from ADC 122 and output two separate streams of data: a first stream with the in-phase (I) component and a second stream with the quadrature (Q) component.

After IQ demodulation, down-converter circuitry 126-1 may convert the I-component from the first sampling rate to a second sampling rate that is lower than the first sampling rate. The down-converted I-component data is labeled I’ in FIG. 9. In parallel, down-converter circuitry 126-2 may convert the Q-component from the first sampling rate to the second sampling rate. The down-converted Q-component data is labeled Q’ in FIG. 9. The second sampling rate may be called a low-speed sampling rate. Down-converting the sampling rate may allow for the envelope of the wireless power transfer signal to be identified. The low-speed sampling rate may be in the order of kilo-samples per second (kS/s), such as 40 kS/s. As shown in FIG. 9, operations performed by ASK communication receiving circuitry 104 before down-conversion may be referred to as being performed in the high-speed domain (e.g., at the first sampling rate) whereas operations performed by ASK communication receiving circuitry 104 after down-conversion may be referred to as being performed in the low-speed domain (e.g., at the second sampling rate).

After down-conversion, amplitude modulation compensation circuitry 128-1 may compensate the I’ data for amplitude modulation caused by frequency dithering of the wireless power transfer signal. The data may be compensated by multiplying the data by compensation factors that offset for amplitude modulation caused by the frequency dithering. The compensated I-component data is labeled I” in FIG. 9. Similarly, amplitude modulation compensation circuitry 128-2 may compensate the Q’ data for amplitude modulation caused by frequency dithering of the wireless power transfer signal. The data may be compensated by multiplying the data by compensation factors that offset for amplitude modulation caused by the frequency dithering. The compensated Q-component data is labeled Q” in FIG. 9.

The compensated data I” and Q” is received by ASK decoding circuitry 130. The compensated data I” and Q” is compensated for amplitude modulation caused by frequency dithering of the wireless power transfer signal. Therefore, resulting amplitude modulation detected by ASK decoding circuitry 130 may be attributable to ASK communications.

The example in FIG. 9 of down-converting to the low-speed domain is merely illustrative. If desired, amplitude modulation compensation circuitry 128 may operate in the high-speed domain (e.g., by calculating and subsequently applying compensation factors based on the high sampling rate samples output by ADC 122).

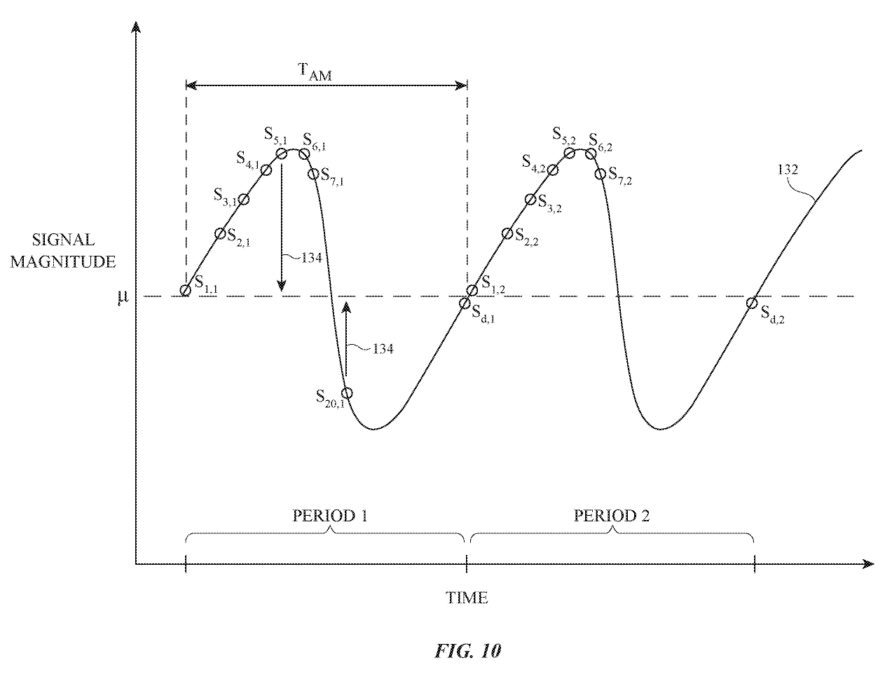

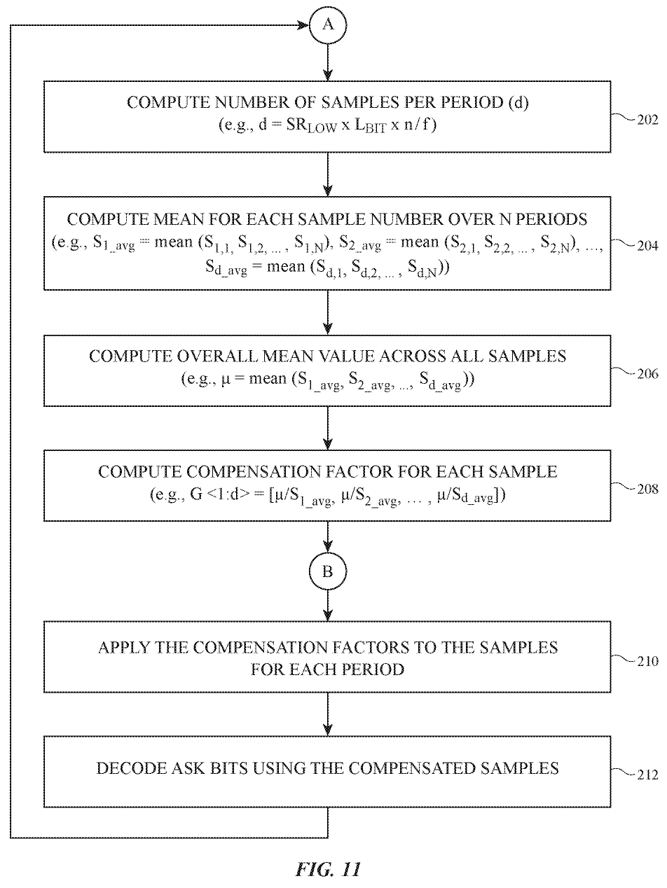

FIG. 10 is a schematic diagram of a waveform with amplitude modulation showing how the aforementioned signal compensation factors may be computed. FIG. 10 shows a waveform 132 representing the upper signal envelope of the I’ data. Without frequency dithering, the waveform 132 would be flat, as discussed above with reference to FIG. 8. In FIG. 10, because of the frequency dithering, waveform 132 has periodic amplitude modulations.

The period T_{AM} of the amplitude modulation may be determined and used to identify optimal compensation factors to compensate for amplitude modulation caused by frequency dithering. The period T_{AM} may be calculated by dividing the number of frequency steps (n) in the frequency dithering pattern by the wireless power transmission frequency (f) (e.g., T_{AM} = n/f). In the example of FIG. 5 where there are 32 frequency steps and the wireless power transmission frequency is 360kHz, T_{AM} is equal to 88 microseconds (e.g., 32/360kHz = 88µs). After computing T_{AM}, amplitude modulation compensation circuitry 128-1 may determine the number of compensation factors (d) that will be applied during each period of the amplitude modulation. The magnitude of d may be equal to the low-speed sampling rate (SR_{LOW}) multiplied by an oversampling ratio (L_{BIT} with units of samples/bit) multiplied by the period T_{AM} (e.g., d = SR_{LOW} x L_{BIT} x T_{AM}). The oversampling ratio may be equal to 18 samples/bit, 20 samples/bit, or any other desired magnitude (e.g., greater than 10 samples/bit, less than 50 samples/bit, etc.). As a first example, SR_{LOW} may be equal to 40kS/s, L_{BIT} may be equal to 18 samples/bit, and T_{AM} may be equal to 88µs. In this first example, d = 64. As a second example, SR_{LOW} may be equal to 20kS/s, L_{BIT} may be equal to 18 samples/bit, and T_{AM} may be equal to 88µs. In this second example, d = 32. As a third example, SR_{LOW} may be equal to 40kS/s, L_{BIT} may be equal to 20 samples/bit, and T_{AM} may be equal to 100µs. In this third example, d = 80. As a fourth example, SR_{LOW} may be equal to 40kS/s, L_{BIT} may be equal to 20 samples/bit, and T_{AM} may be equal to 50µs. In this fourth example, d = 40.

It is noted that the computing of T_{AM} may be integrated into the calculation for d if desired (e.g., d = SR_{LOW} x L_{BIT} x T_{AM} = SR_{LOW} x L_{BIT} x n/f). After determining the magnitude of d, amplitude modulation compensation circuitry 128-1 may compute the average for each sample number (1:d) across a number (N) of periods of waveform 132.

In the example of FIG. 10, the waveform 132 has a first period and subsequent second period. Each sample in the first period is identified using the notation S_{x,y}, where x is the sample number between 1 and d and y is the number of the period. The first sample for the first period is identified as S_{1,1}, the second sample for the first period is identified as S_{2,1}, etc. The final sample for the first period is identified as S_{d,1}. The first sample for the second period is identified as S_{1,2}, the second sample for the second period is identified as S_{2,2}, etc. The final sample for the second period is identified as S_{d,2}.

The average for each sample number over N periods may then be computed. Consider the first sample in each period (e.g., S_{1,1}, S_{1,2, …}, S_{1,N}). The average S_{1_avg} may be equal to the mean of S_{1,1}, S_{1,2, …} , S_{1,N}. This process may be repeated for the second sample in each period (e.g., S_{2_avg} = mean (S_{2,1}, S_{2,2, … 4} S_{2,N})) through the final sample (d) in each period (e.g., S_{d_avg} = mean (S_{d,1}, S_{d,2, …} , S_{d,N})).

After the averages for each sample number are computed (e.g., S_{1_avg}, S_{2_avg}, …, S_{d_avg}), the overall mean value (µ) across all samples in the N periods may be computed (e.g., µ = mean (S_{1_avg}, S_{2_avg}, …, S_{d_avg})). The overall mean µ is marked by the dashed line in FIG. 10.

A compensation factor (G) may then be computed for each sample number by dividing the overall average (µ) by the average for each sample number (e.g., G <1:d> = [µ/S_{1_avg}, µ/S_{2_avg}, … , µ/S_{d_avg}]). Each compensation factor may therefore cause the signal magnitude to be shifted to approximately the overall average (µ) when multiplied by the signal magnitude (see arrows 134 in FIG. 10). Consider the example of sample 5 in FIG. 10. First, S_{5_avg} may be computed as the mean of S_{5,1}, S_{5,2, …} , S_{5,N}. The compensation factor G₅may be computed as µ/S_{5_avg}. During subsequent compensation operations, the 5^{th} sample (S₅) of each period may be multiplied by G₅ to obtain a compensated value S₅’ (e.g., S₅’ = G₅ x S₅). Because G₅ is equal to µ/S_{5_avg}, S₅’ will be approximately equal to µ. Applying the compensation factor to each sample in a given period will cause the waveform for that period to be (in the absence of ASK communications) approximately flat (with each sample approximately equal to µ). Amplitude modulation in the compensated waveform is therefore caused by ASK communications and decoded by ASK decoding circuitry 130. Conceptually, the compensation factors are unitless and in some implementations have a range of between 0.9 and 1.1, between 0.8 and 1.2, greater than 0.5, less than 1.5, so forth.

As shown in the diagram of FIG. 9, example amplitude modulation compensation circuitry 128-1 may compensate I’ data whereas example amplitude modulation compensation circuitry 128-2 may compensate Q’ data. In such an implementation, the aforementioned techniques for computing signal compensation factors may be performed in both amplitude modulation compensation circuitries 128-1 and 128-2. Amplitude modulation compensation circuitry 128-1 determines compensation factors for the I’ data and outputs compensated I” data using those compensation factors. Simultaneously, amplitude modulation compensation circuitry 128-2 determines compensation factors for the Q’ data and outputs compensated Q” data using those compensation factors.

FIG. 11 is a flowchart showing an illustrative method of operating a power transmitting device with ASK communication receiving circuitry that includes amplitude modulation compensation circuitry. During the operations of block 202, control circuitry 16 (e.g., amplitude modulation circuitry 128-1) may compute the number of samples per period (d) using the formula d = SR_{LOW} x L_{BIT} x n/f. In this formula, n/f is equal to the period T_{AM} of the amplitude modulation of the upper envelope of the wireless power transfer signal caused by frequency dithering of the wireless power transfer signal.

During the operations of block 204, control circuitry 16 (e.g., amplitude modulation circuitry 128-1) may compute the average of each sample number over a number (N) of periods of the amplitude modulation. The samples may be samples of an envelope of the wireless power transfer signal. N may be equal to 5, 10, 20, an integer less than 10, an integer less than 20, an integer greater than 10, an integer greater than 20, etc. Each period may have the same number of samples (d). The first sample from each period may be averaged into a first sample average (e.g., S_{1_avg} = mean (S_{1,1}, S_{1,2, …} , S_{1,N})), the second sample from each period may be averaged into a second sample average (e.g., S_{2_avg} = mean (S_{2,1}, S_{2,2, …} , S_{2,N})), etc.

During the operations of block 206, control circuitry 16 (e.g., amplitude modulation circuitry 128-1) may compute the overall average (µ) across all samples over the number (N) of periods of the amplitude modulation (e.g., µ = mean (S_{1_avg}, S_{2_avg}, …, S_{d_avg})).

During the operations of block 208, control circuitry 16 (e.g., amplitude modulation circuitry 128-1) may compute a compensation factor for each sample number between 1 and d (e.g., G <1:d> = [µ/S_{1_avg}, µ/S_{2_avg}, … , µ/S_{d_avg}]). The compensation factors therefore have the effect of normalizing the samples to µ when multiplied by the sample magnitude.

The operations of block 202-208 may be performed during a first period (labeled period A in FIG. 11). The first period may be a quiet period when no data packets are transmitted by PRX 24 to PTX 12.

There are multiple options for detecting the quiet period (sometimes called an idle period) when no data packets are transmitted by PRX 24 to PTX 12. ASK communication receiving circuitry 104 may include a secondary mechanism such as a spectrum analyzer that detects quiet periods (sometimes called a spectrum sniffer). Instead or in addition, ASK communication receiving circuitry 104 may include a rewind memory implemented as a circular buffer. After an ASK packet is detected, the amplitude data from a time preceding the detected ASK packet may be accessed from the circular buffer and used for calculating the compensation factors during the operations of blocks 202-208. Instead or in addition, ASK communication receiving circuitry 104 may use a continuous tracking mechanism that periodically calculates compensation factors as in the operations of blocks 202-208 and stores the calculated compensation factors in a ping-pong buffer. Calculated compensation factors that correspond to conflicts between a quiet period and a data communications period may be abandoned. Any other desired techniques for detecting the quiet period may be used by PTX 12.

After computing the compensation factors during the operations of block 208, control circuitry 16 (e.g., amplitude modulation circuitry 128-1) may apply the compensation factors to the samples for each period during the operations of block 210. The operations of blocks 210 and 212 may be performed during a second period (labeled period B in FIG. 11). The second period may be a data communications period where data packets are transmitted by PRX 24 to PTX 12. During the data communications period (sometimes called a data communications time, data communications duration, data communications interval, data communications phase, in-band communications period, etc.), PTX 12 receives data communication representing data packets that are modulated by PRX 24 into the wireless power transfer signal. PTX 12 may decode the data packets from the wireless power transfer signal.

To apply the compensation factors during the operations of block 210, control circuitry 16 may multiply a given sample by a compensation factor according to the sample number of the given sample. For example, the first sample S₁ of each period is multiplied by a first compensation factor G₁ to obtain a compensated first sample S₁’, the second sample S₂ of each period is multiplied by a second compensation factor G₂ to obtain a compensated second sample S₂’, etc. The final sample S_{d} in each period is multiplied by compensation factor G_{d} to obtain a compensated sample S_{d}’. Multiplying each sample by a respective compensation factor scales out the amplitude modulations caused by the variable gain of the inductive communication channel from the wireless power transfer signal such that the compensated wireless power transfer signal has remaining amplitude modulations caused only by ASK communications.

After the samples are compensated during the operations of block 210, control circuitry 16 (e.g., ASK decoding circuitry 130) may decode ASK bits from the wireless power transfer signal during the operations of block 212. The ASK bits may be decoded using the compensated samples from block 210.

The operations of blocks 202-210 may be performed in parallel by amplitude modulation compensation circuitry 128-1 and 128-2. Amplitude modulation compensation circuitry 128-1 determines compensation factors for I’ data (in blocks 202-208 during a quiet period) and uses the compensation factors to generate compensated I” data (in block 210 during in-band communications). Amplitude modulation compensation circuitry 128-2 determines compensation factors for Q” data (in blocks 202-208 during a quiet period) and uses the compensation factors to generate compensated Q” data (in block 210 during in-band communications). At block 212, ASK decoding circuitry 130 may use the compensated I” data and/or the compensated Q” to decode ASK bits during in-band communications.

The decoded ASK bits may constitute data packets that are used to negotiate and control power transfer between PTX 12 and PRX 24. PTX 12 and/or PRX 24 may operate according to a standard for wireless charging (e.g., the Qi standard as specified by the Wireless Power Consortium organization). The data packets received using ASK may include a device capabilities packet as defined by a Wireless Power Consortium standard, a control error packet as defined by a Wireless Power Consortium standard, a received power packet as defined by a Wireless Power Consortium standard, an auxiliary data control packet as defined by a Wireless Power Consortium standard, and/or any other desired type of data packets. A device capabilities (e.g., Extended Power Capabilities or ECAP) packet may contain the minimum power level the PRX needs for charging, the maximum number of concurrent data streams the PRX can support, the size of the receiving data stream buffer, etc. The control error packet may include feedback about the desired power level (e.g., an integer value that is a relative measure for the deviation between the actual and target operating points for the PRX). These data packets are important in facilitating robust systems for the physical transfer of wireless power across an ecosystem of PTX and PRX devices.

The foregoing is merely illustrative and various modifications can be made to the described embodiments. The foregoing embodiments may be implemented individually or in any combination.

What is claimed is:

1. A power transmitting device comprising:
a wireless power transfer coil configured to transmit wireless power to an additional wireless power transfer coil of a power receiving device;
an inverter configured to receive switching signals based on a dithered clock signal and output a wireless power transfer signal to the wireless power transfer coil; and
a data communications receiver coupled to the wireless power transfer coil and configured to receive data communications from the power receiving device,
wherein the wireless power transfer coil and the additional wireless power transfer coil establish an inductive communication channel that experiences variable gain sensitive to signal frequency,
wherein the wireless power transfer signal is dithered, using the dithered clock signal, about a nominal wireless power transmission frequency,
wherein the data communications receiver is further configured to:
normalize the wireless power transfer signal by compensating for amplitude modulations related to the variable gain of the inductive communication channel, and
decode, using the normalized wireless power transfer signal, amplitude modulations related to amplitude-shift-keying communications to obtain the data communications from the power receiving device, and
wherein the data communications from the power receiving device are used to negotiate and control power transfer between the power transmitting device and the power receiving device.

2. The power transmitting device of claim 1, wherein compensating for the amplitude modulations related to the variable gain of the inductive communication channel comprises obtaining compensation factors that are each associated with a respective portion of a period of the amplitude modulations caused by the variable gain of the inductive communication channel.

3. The power transmitting device of claim 2, wherein each compensation factor is configured to normalize the wireless power transfer signal.

4. The power transmitting device of claim 3, wherein normalizing the wireless power transfer signal comprises scaling out a portion of the amplitude modulations caused by the variable gain of the inductive communication channel and wherein scaling out the portion of the amplitude modulations caused by the variable gain of the inductive communication channel causes remaining amplitude modulations in the wireless power transfer signal to be the amplitude modulations related to the amplitude-shift-keying communications.

5. The power transmitting device of claim 2, wherein the dithered clock signal has a plurality of frequency steps in a repeated cycle and wherein the compensation factors are associated with respective steps of the plurality of frequency steps in the repeated cycle.

6. The power transmitting device of claim 2, wherein obtaining the compensation factors comprises obtaining the compensation factors during a first time during which amplitude-shift-keying communications are not transmitted by the power receiving device to the power transmitting device.

7. The power transmitting device of claim 2, wherein the data communications receiver comprises:
an analog-to-digital converter coupled to the wireless power transfer coil and outputs digital data representing the wireless power transfer signal;
IQ demodulation circuitry that demodulates the digital data into an I-component and a Q-component;
first down-converter circuitry that converts the I-component from a first sampling rate to a second sampling rate that is lower than the first sampling rate;
second down-converter circuitry that converts the Q-component from the first sampling rate to the second sampling rate;
first amplitude modulation compensation circuitry configured to multiply each sample from the first down-converter circuitry by one of the compensation factors; and
second amplitude modulation compensation circuitry configured to multiply each sample from the second down-converter circuitry by one of the compensation factors.

8. The power transmitting device of claim 1, wherein the data communications comprise one or more of a capabilities packet indicating power receiving capabilities of the power receiving device and a control error packet indicating power requirements of the power receiving device.

9. The power transmitting device of claim 1, wherein the data communications receiver is configured to determine, from the wireless power transfer signal including the amplitude modulations caused by the amplitude-shift-keying communications and the amplitude modulations caused by the variable gain of the inductive communication channel, the amplitude modulations related to the amplitude-shift-keying communications.

10. A method of operating a power transmitting device comprising a wireless power transfer coil configured to transmit wireless power to an additional wireless power transfer coil of a power receiving device, an inverter configured to receive switching signals based on a dithered clock signal and output a wireless power transfer signal to the wireless power transfer coil, and a data communications receiver coupled to the wireless power transfer coil and configured to receive data communications from the power receiving device, wherein the wireless power transfer signal is dithered, using the dithered clock signal, about a nominal wireless power transmission frequency, the method comprising:
using the wireless power transfer coil and the additional wireless power transfer coil, establishing an inductive communication channel that experiences variable gain sensitive to signal frequency;
normalizing the wireless power transfer signal by compensating for amplitude modulations related to the variable gain of the inductive communication channel;
decoding, using the normalized wireless power transfer signal, amplitude modulations related to amplitude-shift-keying communications to obtain the data communications from the power receiving device; and
negotiating and controlling power transfer between the power transmitting device and the power receiving device using the data communications from the power receiving device.

11. The method of claim 10, wherein compensating for the amplitude modulations related to the variable gain of the inductive communication channel comprises obtaining compensation factors that are each associated with a respective portion of a period of the amplitude modulations caused by the variable gain of the inductive communication channel.

12. The method of claim 11, wherein each compensation factor is configured to normalize the wireless power transfer signal.

13. The method of claim 12, wherein normalizing the wireless power transfer signal comprises scaling out a portion of the amplitude modulations caused by the variable gain of the inductive communication channel and wherein scaling out the portion of the amplitude modulations caused by the variable gain of the inductive communication channel causes remaining amplitude modulations in the wireless power transfer signal to be the amplitude modulations related to the amplitude-shift-keying communications.

14. The method of claim 11, wherein the dithered clock signal has a plurality of frequency steps in a repeated cycle and wherein the compensation factors are associated with respective steps of the plurality of frequency steps in the repeated cycle.

15. The method of claim 11, wherein obtaining the compensation factors comprises obtaining the compensation factors during a first time during which amplitude-shift-keying communications are not transmitted by the power receiving device to the power transmitting device.

16. The method of claim 10, wherein the data communications comprise one or more of a capabilities packet indicating power receiving capabilities of the power receiving device and a control error packet indicating power requirements of the power receiving device.

17. The method of claim 10, further comprising:
determining, from the wireless power transfer signal including the amplitude modulations caused by the amplitude-shift-keying communications and the amplitude modulations caused by the variable gain of the inductive communication channel, the amplitude modulations related to the amplitude-shift-keying communications.

18. A non-transitory computer-readable storage medium storing one or more programs configured to be executed by one or more processors of a power transmitting device comprising a wireless power transfer coil configured to transmit wireless power to an additional wireless power transfer coil of a power receiving device, an inverter configured to receive switching signals based on a dithered clock signal and output a wireless power transfer signal to the wireless power transfer coil, and a data communications receiver coupled to the wireless power transfer coil and configured to receive data communications from the power receiving device, wherein the wireless power transfer signal is dithered, using the dithered clock signal, about a nominal wireless power transmission frequency, the one or more programs including instructions for:
using the wireless power transfer coil and the additional wireless power transfer coil, establishing an inductive communication channel that experiences variable gain sensitive to signal frequency;
normalizing the wireless power transfer signal by compensating for amplitude modulations related to the variable gain of the inductive communication channel;
decoding, using the normalized wireless power transfer signal, amplitude modulations related to amplitude-shift-keying communications to obtain the data communications from the power receiving device; and
negotiating and controlling power transfer between the power transmitting device and the power receiving device using the data communications from the power receiving device.

19. The non-transitory computer-readable storage medium of claim 18, wherein compensating for the amplitude modulations related to the variable gain of the inductive communication channel comprises obtaining compensation factors that are each associated with a respective portion of a period of the amplitude modulations caused by the variable gain of the inductive communication channel.

20. The non-transitory computer-readable storage medium of claim 18, wherein the data communications comprise one or more of a capabilities packet indicating power receiving capabilities of the power receiving device and a control error packet indicating power requirements of the power receiving device.
